(19) United States
(12) Patent Application Publication
(10) Pub. No.: US 2014/0026701 A1
(43) Pub. Date: Jan. 30, 2014

(54) POWER MODULE CAPABLE OF INTERMITTENTLY ROTATING GRILL RACK

(71) Applicant: Huang-Hsi HSU, Taipei, (TW)

(72) Inventor: Huang-Hsi HSU, Taipei, (TW)

(21) Appl. No.: 13/668,370

(22) Filed: Nov. 5, 2012

(30) Foreign Application Priority Data
Jul. 24, 2012 (TW) 101126586

(51) Int. Cl. F16H 55/17

(52) U.S. Cl. 74/421 R

(57) ABSTRACT

The present invention is to provide a power module including a housing and a gear set, wherein the housing is installed on an outer side of a grill burner, and the gear set is fixedly provided in the housing and includes an intermittent gear and an output gear. The intermittent gear has a circumferential surface provided with an intermittently toothed portion along the axial direction of the intermittent gear and can be rotated by a motor, wherein the intermittently toothed portion includes a toothed zone and a toothless zone. The gear shaft of the output gear has one end exposed from the housing and connecting to the grill rack. Thus, when the intermittently toothed portion meshes with the output gear, the grill rack can be intermittently rotated above the grill burner, allowing the heat source in the grill burner to heat the food on the grill rack evenly.

### FIELD OF THE INVENTION

The present invention relates to a power module, more particular to a power module capable of intermittently rotating a grill rack above a grill burner, so as to allow heat source in the grill burner to heat food on the grill rack evenly.

### BACKGROUND OF THE INVENTION

Recently, people's way of life has gradually changed with the development of economic and trade activities. In addition to pursuing material enjoyment, more and more attention is paid to the enhancement of the spiritual life. Hence, people are placing increasing importance on recreation, and the various recreational activities provide tremendous business opportunities for the recreational industry. Barbecues, for example, are a very popular activity to be held outdoors. Generally speaking, if one side of the food being barbecued is left facing the heat source for a long time, this side of the food is very likely to be overheated or even charred while the side facing away from the heat source is undercooked due to insufficiently heating. It is therefore necessary to turn the food regularly so that each part of the food is heated evenly. If several pieces of food are grilled at the same time and are to be manually turned with a pair of tongs, the one in charge of grilling (hereinafter referred to as the user) must keep a close eye on the heated state of each piece, usually so close that the user is unable to take part in other activities (e.g., chatting, singing, or playing games) at the same time. In addition, the user must watch the high temperature of the heat source so as not to be burned when turning the food. If there are a good number of pieces of food on the grill rack, chances are the user will lose track of whether a certain piece has been turned, hence leaving some unturned for quite a while but turning the others too frequently. Thus, the problem of uneven heating remains, and some of the pieces end up partly charred and partly raw. These poorly cooked pieces are not good for health if consumed and will be a waste of food if discarded.

In view of the fact that the manual side-turning operation in the grilling process demands the user's full attention but does not guarantee uniform heating, the inventor of the present application devised a “rotating grill rack”. This rotating grill rack, indicated generally with the reference numeral 1 in FIG. 1 and hereinafter referred to as the grill rack for short, includes a supporting rod 11, a metal frame 12, and a supporting frame 13. The supporting rod 11 has one end connected to the output shaft of a motor (not shown) and the other end fixedly provided on the metal frame 12, thus allowing the motor to rotate the metal frame 12 via the supporting rod 11. The metal frame 12 has two opposite ends each penetrated by two parallel position-limiting slide grooves 120. The supporting frame 13 is configured for receiving food therein and has two opposite ends each provided with two insertion rods 130. The insertion rods 130 can be movably inserted into the corresponding position-limiting slide grooves 120. When the metal frame 12 is rotated by the motor via the supporting rod 11, the tilt angle of the position-limiting slide grooves 120 is changed, and because of that, the insertion rods 130 are driven by the weight of the supporting frame 13 to slide reciprocally between one and the other ends of the corresponding position-limiting slide grooves 120. Hence, in the course where the metal frame 12 is rotated by the motor, each 180-degree rotation of the metal frame 12 will turn the side of the supporting frame 13 that faces away from the heat source toward the heat source, and the food received in the supporting frame 13 will turn along with the supporting frame 13. Now that the food or different pieces of food in the supporting frame 13 are turned at the same frequency, uneven heating which may otherwise result from turning the pieces differently is prevented.

However, despite that driving the grill rack 1 with a motor can turn the different pieces of food in the supporting frame 13 at the same frequency and thereby prevent uneven heating which may otherwise result from a non-uniform manual side-turning operation, the inventor has recently found that rotating the grill rack 1 at a fixed angular speed may still lead to uneven heating, caused mainly by the different distances between the supporting rod 11 (i.e., the axis of rotation) and different positions on the supporting frame 13. Owing to such different distances, the pieces of food received in the central portion of the supporting frame 13 undergo a smaller change of distance from the heat source than those on the two lateral sides of the supporting frame 13 when the metal frame 12 is rotated by the motor. In consequence, the pieces received in different parts of the supporting frame 13 are still heated differently. If the grill rack 1 is rotated at a fixed angular speed, which causes the tilt angle of the supporting frame 13 to vary constantly, the pieces received in different parts of the supporting frame 13 will be differently spaced from the heat source in most of the time. Only when the supporting frame 13 is horizontal will the pieces in different parts of the supporting frame 13 be heated relatively uniformly.

According to the above, although the motor-driven grill rack 1 can effectively prevent uneven heating which may otherwise result from turning plural pieces of food at different frequencies, the pieces received in different parts of the supporting frame 13 will still be heated unevenly if the grill rack 1 is rotated at a fixed angular speed. It can be concluded that uneven heating will persist unless the manner of rotation of the grill rack 1 can be changed. Therefore, the issue to be addressed by the present invention is to design a power module which can change the way the grill rack 1 is rotated. It is desirable that, during rotation of the grill rack 1, the supporting frame 13 will stay in the horizontal state for a relatively long time to subject different parts of the supporting frame 13 to relatively uniform heating conditions, thereby effectively and totally preventing uneven heating.

### BRIEF SUMMARY OF THE INVENTION

In view of the popularity of barbecue, and in order to increase the quality of such an activity, the inventor of the present invention has long been dedicated to the development of barbecue-related products that can satisfy users' needs and make barbecue more convenient. In the spirit of constant improvement, the inventor put years of practical experience into repeated trials and finally succeeded in developing a power module capable of intermittently rotating a grill rack. With the present invention, the uneven heating conditions in different parts of a conventional grill rack can be rendered relatively uniform to effectively and totally prevent uneven heating of food. The present invention also facilitates barbecuing.

It is an object of the present invention to provide a power module capable of intermittently rotating a grill rack. The power module includes a housing and a gear set. The housing is installed on and fixed to an outer side of a grill burner. The gear set is fixedly provided in the housing and at least includes an intermittent gear and an output gear. The intermittent gear can be driven to rotate by an output shaft. The circumferential surface of the intermittent gear is provided with an intermittently toothed portion along the axial direction of the intermittent gear, wherein the intermittently toothed portion includes a toothed zone and a toothless zone. The gear shaft of the output gear has one end exposed from the housing and configured for connection with a grill rack. When the toothed zone meshes with the output gear, the output gear can be driven to rotate by the intermittent gear such that the grill rack is rotated synchronously. When the toothless zone is rotated to a position corresponding to the output gear, neither the output gear nor the grill rack can be driven to rotate by the output shaft. Thus, the grill rack is intermittently rotatable above the grill burner, allowing the heat source in the grill burner to heat the food on the grill rack evenly.

Another object of the present invention is to provide a power module capable of intermittently rotating a grill rack, wherein the power module includes a housing and a gear set, the housing being installed on and fixed to an outer side of a grill burner, the gear set being fixedly provided in the housing and at least including an input gear, an intermittent gear, and an output gear. The input gear can be driven to rotate by an output shaft. The circumferential surface of the intermittent gear is provided with a continuously toothed portion and an intermittently toothed portion along the axial direction of the intermittent gear. The continuously toothed portion is circumferentially provided with continuous teeth. The intermittently toothed portion includes a toothed zone and a toothless zone. The teeth in the toothed zone extend from the teeth of the continuously toothed portion. The toothless zone has no teeth. The gear shaft of the output gear has one end pivotally connected in the housing and an opposite end exposed from the housing and configured for connection with a grill rack. When the input gear meshes with the continuously toothed portion and the output gear meshes with the intermittently toothed portion, the input gear can drive the intermittent gear to rotate continuously, and the intermittent gear will, in turn, drive the output gear into rotation. When the toothless zone is rotated to a position corresponding to the output gear, neither the output gear nor the grill rack can be driven to rotate by the output shaft. Thus, the grill rack is intermittently rotatable above the grill burner, allowing the heat source in the grill burner to heat the food on the grill rack evenly.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a schematic drawing of a conventional rotating grill rack;

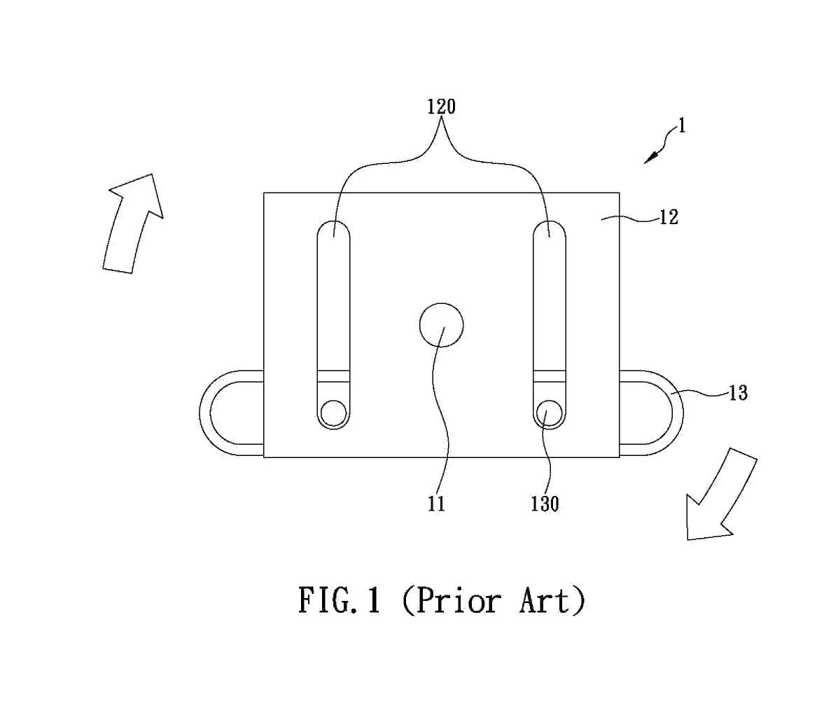

FIG. 2 is a perspective view showing how the present invention is applied to a grill burner;

FIG. 3 shows the gear set in the first preferred embodiment of the present invention;

FIG. 4A shows the gear set in the second preferred embodiment of the present invention, wherein the gear set is in an intermittent rotation mode;

FIG. 4B shows the gear set in the second preferred embodiment of the present invention, wherein the gear set is in a continuous rotation mode;

FIG. 5 shows the gear set in the third preferred embodiment of the present invention; and

FIG. 6 is a sectional view of the gear set in the fourth preferred embodiment of the present invention.

### DETAILED DESCRIPTION OF THE INVENTION

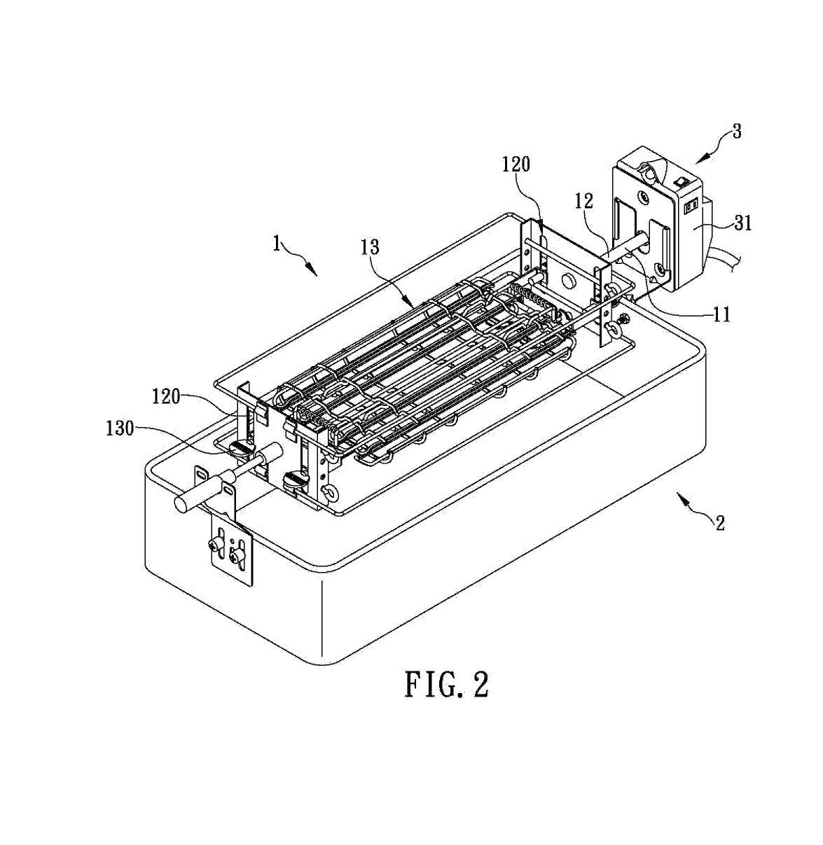

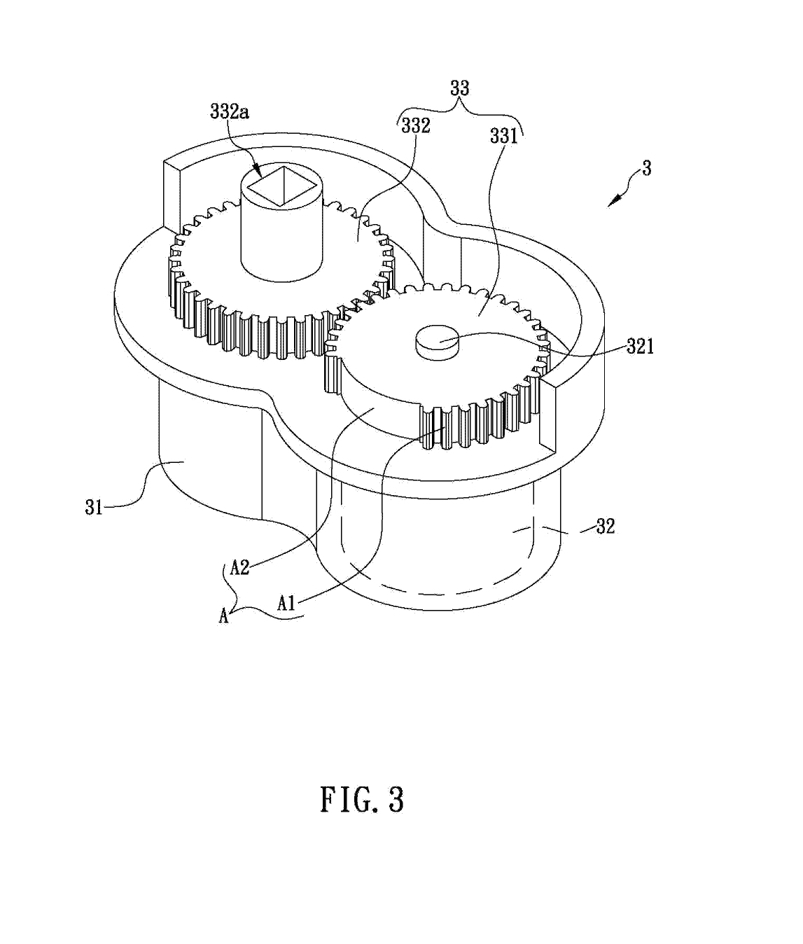

The present invention discloses a power module capable of intermittently rotating a grill rack. Referring to FIG. 2 and FIG. 3, the power module 3 in the first preferred embodiment of the present invention includes a housing 31, a motor 32, and a gear set 33. The housing 31 is installed on and fixed to an outer side of a grill burner 2, wherein the grill burner 2 provides a heat source. For example, the heat source can be provided by burning charcoal in the grill burner 2 or by a halogen lamp in the grill burner 2. When a grill rack 1 is mounted above the grill burner 2 at a position corresponding to the heat source, a supporting rod 11 of the grill rack 1 can be inserted into and thus connected to the power module 3, so as for the power module 3 to drive the grill rack 1 to rotate above the heat source. The motor 32 is fixedly provided in the housing 31, and so is the gear set 33. The gear set 33 at least includes an intermittent gear 331 and an output gear 332. The intermittent gear 331 can be driven to rotate by an output shaft 321 of the motor 32. The circumference of the intermittent gear 331 is provided with an intermittently toothed portion A. The intermittently toothed portion A includes a toothed zone A1 and a toothless zone A2. The gear shaft of the output gear 332 has one end exposed from the housing 31. In this embodiment, the gear shaft of the output gear 332 is formed with an insertion hole 332a into which the supporting rod 11 can be inserted so as to connect to the gear shaft. Thus, when driven to rotate, the output gear 332 drives the grill rack 1 through the supporting rod 11, causing the grill rack 1 to rotate along with the output gear 332. When the toothed zone A1 of the intermittent gear 331 is rotated to a position corresponding to the output gear 332, the output gear 332 meshes with the toothed zone A1 and can be driven to rotate by the motor 32 through the intermittent gear 331, thus allowing the grill rack 1 to be rotated by the motor 32. When the toothless zone A2 is rotated to a position corresponding to the output gear 332, however, neither the output gear 332 nor the grill rack 1 can be driven to rotate by the motor 32. Hence, by virtue of the toothed zone A1 and the toothless zone A2 of the intermittent gear 331, the intermittent gear 331 can drive the output gear 332 intermittently, so as for the power module 3 to rotate the grill rack 1 intermittently.

Referring to FIG. 2 and FIG. 3, the grill rack 1 in this embodiment consists of a metal frame 12 and a supporting frame 13 in addition to the supporting rod 11. The supporting rod 11 has one end inserted in the insertion hole 332a and the other end fixedly provided on the metal frame 12. This allows the metal frame 12 to rotate along with the output gear 332. The metal frame 12 has two opposite ends each provided with two position-limiting slide grooves 120. The supporting frame 13 has two opposite ends each provided with two insertion rods 130. The insertion rods 130 are movably engageable in the corresponding position-limiting slide grooves 120 such that, during rotation of the metal frame 12, each insertion rod 130 is driven by the weight of the supporting frame 13 to slide back and forth between one and the other ends of the corresponding position-limiting slide groove 120 in response to variation of the tilt angle of the corresponding position-limiting slide groove 120. As the supporting frame 13 moves reciprocally with respect to the metal frame 12, the center of gravity of the grill rack 1 moves repeatedly from one side to the other side of the supporting rod 11 along the direction of the position-limiting slide grooves 120.

As stated in the first paragraph of this section, the intermittent gear 331 is continuously driven to rotate by the motor 32; however, the output gear 332 will not be driven to rotate unless it meshes with the toothed zone A1. When the toothless zone A2 is rotated to a position corresponding to the output gear 332, the output gear 332 is not subjected to the action of the intermittent gear 331; therefore, the output gear 332 and the grill rack 1 can rotate freely under the action of other external forces. In this embodiment, the grill rack 1, when not subjected to the driving force of the motor 32 or other applied forces, will rotate under the action of gravity to a position in which the supporting frame 13 is horizontal; in other words, the grill rack 1 will be rotated to a position where its center of gravity lies right below the supporting rod 11.

In the present embodiment as shown in FIG. 2 and FIG. 3, the grill rack 1 can be driven to rotate by the motor 32 only when the output gear 332 meshes with the toothed zone A1; therefore, once the toothless zone A2 is rotated to a position corresponding to the output gear 332, the grill rack 1 is no more subjected to the action of the motor 32 and will, under the action of gravity, automatically resume the position in which the supporting frame 13 is horizontal, regardless of the angle to which the grill rack 1 has been rotated by the motor 32. It can be known from the above that a manufacturer of the power module 3 can change the duration for which the supporting frame 13 remains horizontal simply by adjusting the size of the toothless zone A2 (e.g., by changing the ratio between the toothed zone A1 and the toothless zone A2 or by changing the length of the circumference of the entire intermittent gear 331), so as for the food received in different parts of the supporting frame 13 to be subjected to relatively uniform heating conditions, thereby effectively preventing the food from being heated unevenly. It should be pointed out that the grill rack 1 previously invented by the inventor as described in Description of Related Art is so configured that all the pieces of food received therein can be rotated at the same frequency to prevent uneven heating which may otherwise result from turning the pieces differently. By contrast, the power module 3 in the present invention is configured to keep the distances between the heat source and the different pieces of food as uniform as possible during the grilling process. The technical means adopted by the present invention not only are different from but also can be used independent of those adopted by the previous invention. In other words, the power module 3 of the present invention is not necessarily applied to the grill rack 1. When used with other types of grill racks, the power module 3 of the present invention is equally capable of rotating the grill racks intermittently, allowing the grill racks to stay at a specific angle for a longer time. Therefore, when applied to other types of grill racks, the power module 3 of the present invention can prevent food from uneven heating just as well. In short, the present invention is not limited to use with the grill rack 1.

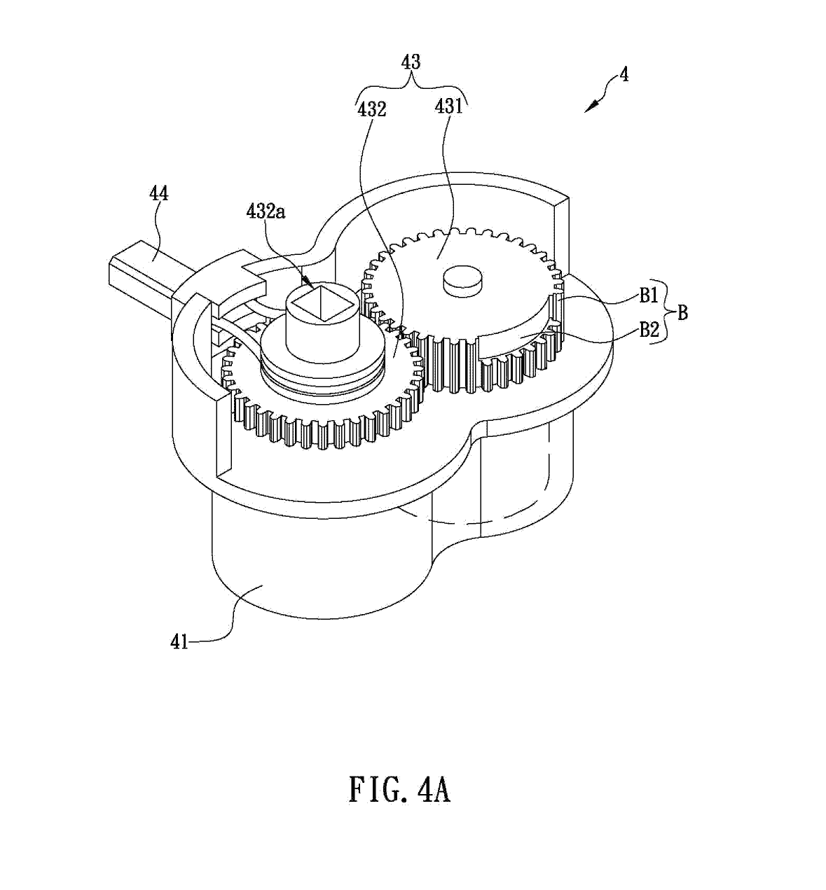

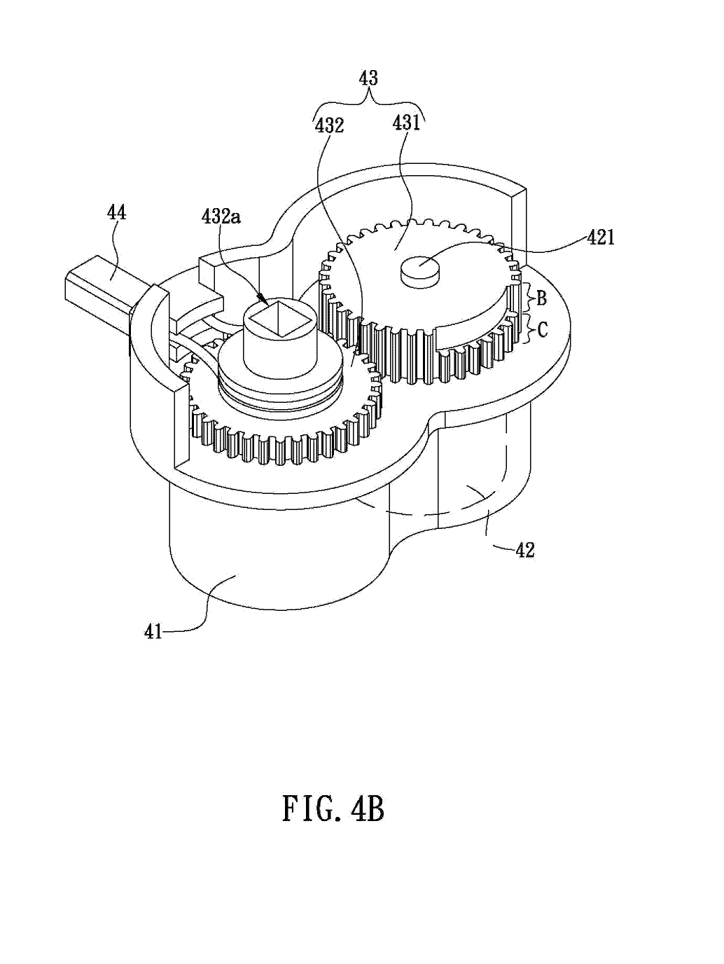

In order for the user to freely select how the grill rack 1 (see FIG. 2) should rotate, the second preferred embodiment of the present invention is provided as shown in FIG. 4A and FIG. 4B. In this embodiment, the grill rack 1 is connected to a power module 4. The power module 4 has a housing 41 in which a motor 42 and a gear set 43 are provided. An intermittent gear 431 in the gear set 43 can be driven to rotate by the motor 42. The circumferential surface of the intermittent gear 431 is provided with a continuously toothed portion C and an intermittently toothed portion B along the axial direction of the intermittent gear 431. The continuously toothed portion C is circumferentially provided with continuous teeth. The intermittently toothed portion B, on the other hand, includes a toothed zone B1 and a toothless zone B2. The teeth in the toothed zone B1 extend from the teeth of the continuously toothed portion C whereas the toothless zone B2 has no teeth. In this embodiment, the gear set 43 has an output gear 432 provided with an insertion hole 432a, and the grill rack 1 is connected to the power module 4 via the insertion hole 432a. The output gear 432 can move along its axial direction. When moved to a position corresponding to the intermittently toothed portion B, the output gear 432 can be driven to rotate by the intermittent gear 431 if meshing with the toothed zone B1 and cannot if corresponding in position to the toothless zone B2; thus, the output gear 432 can drive the grill rack 1 to rotate in an intermittent rotation mode. When moved to a position corresponding to the continuously toothed portion C, the output gear 432 meshes with the continuously toothed portion C and can be driven to rotate by the intermittent gear 431; thus, the output gear 432 can drive the grill rack 1 to rotate in a continuous rotation mode. The power module 4 further includes a pushing member 44. The pushing member 44 has one end extending out of the housing 41 and the other end connected to the output gear 432. By pushing the pushing member 44 from outside the housing 41, the user can move the output gear 432 to either the position corresponding to the intermittently toothed portion B or the position corresponding to the continuously toothed portion C. This allows the user to freely switch the gear set 43 to the intermittent rotation mode or the continuous rotation mode according to practical needs. More specifically, the user only has to push the pushing member 44 from outside the housing 41, thereby moving the output gear 432 to the position corresponding to the intermittently toothed portion B, and the power module 4 will be switched to the intermittent rotation mode, in which the grill rack 1 connected to the power module 4 is intermittently rotatable above the heat source. When the grill rack 1 is subsequently replaced by an object to be grilled (e.g., a whole chicken with a spit inserted therethrough), the user only has to push the pushing member 44 from outside the housing 41 again, thereby moving the output gear 432 to the position corresponding to the continuously toothed portion C, and the power module 4 will be switched to the continuous rotation mode, in which the object to be grilled is continuously rotatable above the heat source.

Referring again to FIG. 4A and FIG. 4B, the circumferential surface of the intermittent gear 431 is provided with only one continuously toothed portion C and only one intermittently toothed portion B along the axial direction of the intermittent gear 431, and yet the present invention is not limited to such an arrangement. In order for a user who has switched the power module 4 to the intermittent rotation mode to further select the way of intermittent rotation (e.g., the frequency at which or the duration for which the power module 4 stops power output), a manufacturer of the power module 4 may provide the intermittent gear 431 with plural tiers of intermittently toothed portions B in which the ratio between the toothed zone B1 and the toothless zone B2 is different from tier to tier. Thus, by pushing the pushing member 44, the output gear 432 can be moved to different intermittently toothed portions B to change the rotation frequency of the grill rack 1 (see FIG. 2), thereby extending or shortening the time for which the supporting frame 13 (see FIG. 2) remains horizontal.

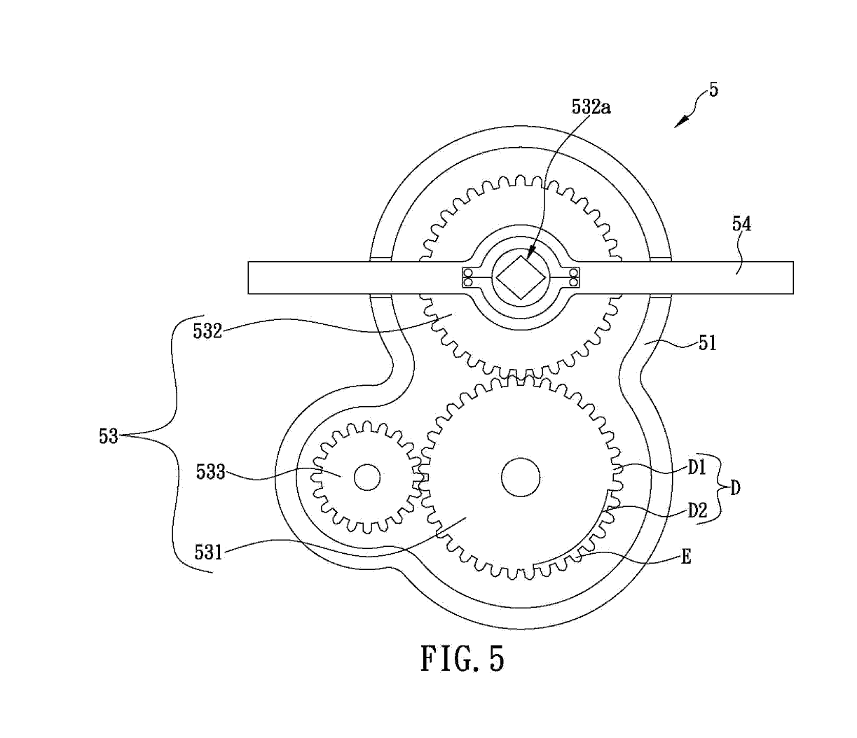

As in the previous embodiment, the intermittent gear 431 is driven to rotate by an output shaft 421 of the motor 42. In this embodiment, the output shaft 421 is the rotating shaft of the rotor of the motor 42, but this is not necessarily so in the present invention. The output shaft 421 may also be a rotating shaft of a reduction gear set (not shown). In that case, the rotor of the motor 42 directly drives a gear in the reduction gear set and transmits this driving force to the intermittent gear 431 through the output shaft 421 of the reduction gear set; nevertheless, the intended effect is equally achievable. Moreover, although the intermittent gear 431 in the present embodiment is directly driven to rotate by the output shaft 421, the present invention is not limited to this configuration, as detailed below. In the third preferred embodiment of the present invention as shown in FIG. 5, the power module 5 has a housing 51 housing a motor (not shown) and a gear set 53, wherein the gear set 53 at least includes an input gear 533, an intermittent gear 531, and an output gear 532. In this embodiment, the input gear 533 can be driven to rotate by an output shaft of the motor. The circumferential surface of the intermittent gear 531 is provided with a continuously toothed portion E and an intermittently toothed portion D along the axial direction of the intermittent gear 531. The continuously toothed portion E is circumferentially provided with continuous teeth and meshes with the input gear 533 so as for the motor to rotate the intermittent gear 531 indirectly (i.e., via the input gear 533). The intermittently toothed portion D includes a toothed zone D1 and a toothless zone D2. The teeth in the toothed zone D1 extend from the teeth of the continuously toothed portion E whereas the toothless zone D2 is free of teeth. The gear shaft of the output gear 532 has one end formed with an insertion hole 532a into which a supporting rod 11 (see FIG. 2) can be inserted. By pushing a pushing member 54 of the power module 5 from outside the housing 51, the user can move the output gear 532 to either a position corresponding to the intermittently toothed portion D or a position corresponding to the continuously toothed portion E, allowing the output gear 532 to either mesh with the toothed zone D1 of the intermittently toothed portion D for intermittent rotation or mesh with the continuously toothed portion E for continuous rotation. As the intermittent gear 531 is driven to rotate by the motor in an indirect manner (i.e., through the input gear 533), a manufacturer of the power module 5 may adjust the output rotation speed or output torsion of the power module 5 by changing the gear ratio between the input gear 533 and the intermittent gear 531. Thus, the manufacturer can optimize the function of the power module 5 with ease.

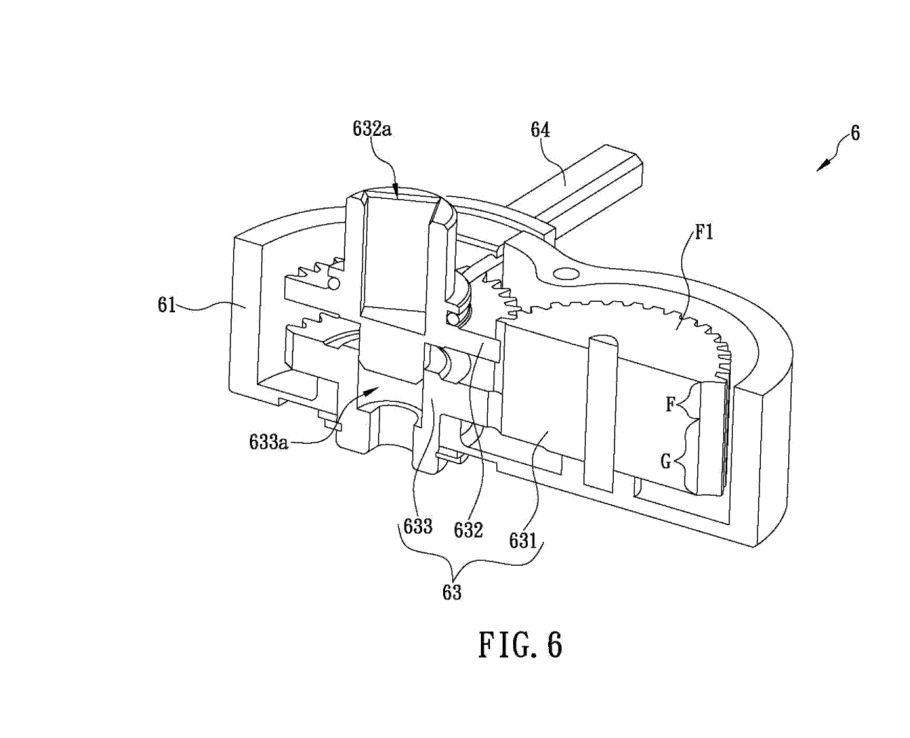

Reference is now made to FIG. 6 for the fourth preferred embodiment of the present invention. The power module 6 has a gear set 63 provided in a housing 61, and the gear set 63 at least includes an input gear 633, an intermittent gear 631, and an output gear 632. In this embodiment, the gear shaft of the output gear 632 is connected to the gear shaft of the input gear 633 in a nesting configuration so that the housing 61 can be effectively downsized. It should be noted, however, that the output gear 632 and the input gear 633 will not rotate with each other. The circumferential surface of the intermittent gear 631 is provided with a continuously toothed portion G and an intermittently toothed portion F along the axial direction of the intermittent gear 631. The continuously toothed portion G is circumferentially provided with continuous teeth while the intermittently toothed portion F includes a toothed zone F1 and a toothless zone (not shown). The gear shaft of the input gear 633 has one end connected to an output shaft (not shown) of a motor so that the input gear 633 can be driven into continuous rotation by the motor. The other end of the gear shaft of the input gear 633 is formed with a nesting hole 633a. In this embodiment, the input gear 633 meshes with the lower half (as shown in the drawing) of the continuously toothed portion G and can therefore drive the intermittent gear 631 to rotate continuously along with the input gear 633. The gear shaft of the output gear 632 has one end formed with an insertion hole 632a into which a supporting rod 11 (see FIG. 2) can be inserted. The other end of the gear shaft of the output gear 632 is movably nested in the nesting hole 633a, allowing the output gear 632 to rotate or to move axially with respect to the input gear 633. In this embodiment, a pushing member 64 of the power module 6 can be pushed from outside the housing 61 to move the output gear 632 along its axial direction either to a position corresponding to the intermittently toothed portion F or to the upper half of the continuously toothed portion G, so as for the output gear 632 to mesh with the toothed zone F1 of the intermittently toothed portion F or with the upper half of the continuously toothed portion G. With the output gear 632 and the input gear 633 connected in a nested configuration, the planar space taken by the gear set 63, and hence the overall volume of the housing 61, can be effectively reduced. It should be pointed out that, while the upper and lower halves of the continuously toothed portion G in this embodiment are of the same specification, a manufacturer of the power module 6 may not only provide the intermittent gear 631 with multiple tiers of intermittently toothed portions F as previously described, but also design a two-tier continuously toothed portion G in which the upper and lower halves of the continuously toothed portion G have different gear radii and tooth numbers (like a common double gear). Thus, the output rotation speed or output torsion of the power module 6 can be adjusted by changing the gear ratio between the lower half of the continuously toothed portion G and the input gear 633.

While the invention herein disclosed has been described by means of specific embodiments, numerous modifications and variations could be made thereto by those skilled in the art without departing from the scope of the invention set forth in the claims.

What is claimed is:

1. A power module capable of intermittently rotating a grill rack, the power module comprising:
a housing installed on and fixed to an outer side of a grill burner; and
a gear set fixedly provided in the housing and comprising an intermittent gear and an output gear, the intermittent gear being drivable to rotate by an output shaft, the intermittent gear having a circumferential surface provided with an intermittently toothed portion along an axial direction of the intermittent gear, the intermittently toothed portion comprising a toothed zone and a toothless zone, the output gear having a gear shaft whose one end is exposed from the housing so as to connect with a grill rack, wherein when the toothed zone meshes with the output gear, the output gear can be driven to rotate by the intermittent gear such that the grill rack is rotated synchronously, and when the toothless zone is rotated to a position corresponding to the output gear, neither the output gear nor the grill rack can be driven to rotate by the output shaft, thus allowing the grill rack to rotate intermittently above the grill burner and hence allowing a heat source in the grill burner to heat food on the grill rack evenly.

2. The power module of claim 1, wherein the circumferential surface of the intermittent gear is further provided with a continuously toothed portion, the continuously toothed portion and the intermittently toothed portion being provided along an axial direction of the intermittent gear, the continuously toothed portion being circumferentially provided with continuous teeth, the toothed zone having teeth extending from the teeth of the continuously toothed portion.

3. The power module of claim 2, further comprising a pushing member having an end extending out of the housing and an opposite end connected to the output gear such that, when pushed from outside the housing, the pushing member drives the output gear to move along an axial direction of the output gear, wherein when the output gear is moved to a position corresponding to the intermittently toothed portion, the output gear can be driven by the intermittently toothed portion, causing the grill rack to rotate intermittently above the grill burner, and when the output gear is moved a position corresponding to the continuously toothed portion, the output gear can be driven by the continuously toothed portion, causing the grill rack to rotate continuously above the grill burner.

4. A power module capable of intermittently rotating a grill rack, the power module comprising:
a housing installed on and fixed to an outer side of a grill burner; and
a gear set fixedly provided in the housing and comprising an input gear, an intermittent gear, and an output gear, the input gear being drivable to rotate by an output shaft, the intermittent gear having a circumferential surface provided with a continuously toothed portion and an intermittently toothed portion along an axial direction of the intermittent gear, the continuously toothed portion being circumferentially provided with continuous teeth, the intermittently toothed portion comprising a toothed zone and a toothless zone, the toothed zone having teeth extending from the teeth of the continuously toothed portion, the toothless zone having no teeth, the output gear having a gear shaft whose one end is exposed from the housing so as to connect with a grill rack, wherein when the input gear meshes with the continuously toothed portion and the output gear meshes with the intermittently toothed portion, the intermittent gear can be driven to rotate continuously by the input gear and can drive the output gear to rotate, and once the toothless zone is rotated to a position corresponding to the output gear, neither the output gear nor the grill rack can be driven to rotate by the output shaft, thus allowing the grill rack to rotate intermittently above the grill burner and hence allowing a heat source in the grill burner to heat food on the grill rack evenly.

5. The power module of claim 4, wherein the gear shaft of the output gear is axially movable to a position in which the output gear meshes with the continuously toothed portion.

6. The power module of claim 5, further comprising a pushing member having an end extending out of the housing and an opposite end connected to the output gear such that, when pushed from outside the housing, the pushing member drives the output gear to move along an axial direction of the output gear, wherein when the output gear is moved to a position corresponding to the intermittently toothed portion, the output gear can be driven by the intermittently toothed portion, causing the grill rack to rotate intermittently above the grill burner, and when the output gear is moved a position corresponding to the continuously toothed portion, the output gear can be driven by the continuously toothed portion, causing the grill rack to rotate continuously above the grill burner.

7. The power module of claim 4, wherein the input gear has a gear shaft whose one end is connected to the output shaft and whose opposite end is formed with a nesting hole in which an opposite end of the gear shaft of the output gear is movably nested.

8. The power module of claim 5, wherein the input gear has a gear shaft whose one end is connected to the output shaft and whose opposite end is formed with a nesting hole in which an opposite end of the gear shaft of the output gear is movably nested.

9. The power module of claim 6, wherein the input gear has a gear shaft whose one end is connected to the output shaft and whose opposite end is formed with a nesting hole in which an opposite end of the gear shaft of the output gear is movably nested.
